(19) United States
(12) Patent Application Publication
(10) Pub. No.: US 2010/0262447 A1
(43) Pub. Date: Oct. 14, 2010

(54) Method and System for Asynchronous and Timed Data Collection Using a Handheld Device

(75) Inventor: David J. Charles, Arlington, MA (US)

Correspondence Address: HOUSTON ELISEEVA, 420 BEDFORD ST, SUITE 155, LEXINGTON, MA, 02420, US

(73) Assignee: PERILLON SOFTWARE, INC., Littleton, MA (US)

(21) Appl. No.: 12/756,214

(22) Filed: Apr. 8, 2010

Related U.S. Application Data
(60) Provisional application No. 61/168,345, filed on Apr. 10, 2009.

(51) Int. Cl. G06Q 50/00; G06Q 10/00

(52) U.S. Cl. 705/7; 705/317

(57) ABSTRACT

A visual emissions field observation system enables the observation and recording of concurrent visual emissions material processing sources with a mobile handheld device executing a software application. A mobile electronic recording system provides a method to support the timed asynchronous collection of data for clustered emission sources in parallel, by providing access to the necessary recording functions for multiple observation sources concurrently, within the same unified view on a handheld computer screen. This can yield significant time savings for the observer.

### RELATED APPLICATIONS

This application claims the benefit under 35 USC 119(e) of U.S. Provisional Application No. 61/168,345, filed on Apr. 10, 2009, which is incorporated herein by reference in its entirety.

### BACKGROUND OF THE INVENTION

Environmental, health and safety (EH&S) activities include manufacturing emission source monitoring to ensure that systems are functioning within both regulated and private limits and that related systems are performing as expected. Observation sources largely exist out-of-doors in the form of “stacks” (process-stacks or ducts) that typically emit chemical gasses. The emissions can be categorized as fugitive emissions, which are those emissions that escape capture by process equipment or are emitted during material transfer.

The observation process is carried out by a trained observer who can ascertain the percentage of visual emission opacity for an emission source and who can then record in the form of a pass or fail value relative to the regulation limits for a given source. Recording methods include manual paper-based recording or usage of electronic recording system, such as a portable laptop (PC), tablet PC, or handheld computer.

These observation processes are structured, in that they typically occur within a specifically regulated timeframe and are conducted for a specifically timed duration. In the case where more than one visual emission point exists in close visual proximity to one another, a timed test of a specific duration is performed in a serial fashion for each unit by an individual person. For example, a 30-minute timed observation that must be completed by one person for four individual, but clustered, emission sources would take an observer a minimum of 120 minutes of elapsed time to record electronically using a serial input method with a conventional electronic recording system.

### SUMMARY OF THE INVENTION

It is desirable to provide a method and system that supports the asynchronous collection activities associated with visual observation sources, while providing access to the necessary shared global functions that are common among all observation sources to ensure that the structural integrity of the data collection activities is maintained. This provides the potential to reduce the elapsed observation time by a factor of the number of sources being observed.

The present invention concerns visual emissions field observation systems and more particularly the observation and recording of concurrent visual emissions material processing sources with a mobile handheld device executing a software application.

A mobile electronic recording system provides a method to support the timed asynchronous collection of data for clustered emission sources in parallel, by providing access to the necessary recording functions for multiple observation sources concurrently, within the same unified view on a handheld computer screen. This can yield significant time savings for the observer.

An intuitive modular layout makes judicious use of the constrained display area of the handheld computer screen. In the case of four concurrent readings, access to the necessary observation functions are made possible by splitting the screen into four sections; one for each observation source. Each quadrant contains a dual-state button that is used to toggle the real-time observation condition for a given observation source and an observation source identifier; to associate a visible observation source to a specific handheld computer screen quadrant.

The shared global handheld computer screen area outside of the structured quadrant screen area provides controls and functions as follows: an automated visible countdown value, a title area, a global start and reset function, an application “Quit” function, and a navigation area to provide access to additional forms within the same handheld computer screen.

The advantages of the present invention can include, without limitation, a significant time reduction through the support for concurrent timed tests bound to a specific and common duration. As a method and system that supports the asynchronous collection activities associated with visual observation sources, and with the mechanism to support the structural integrity of the data collection activities, the elapsed observation time is reduced by a factor of the number of sources being observed.

The system includes a Mobile Handheld Device Software Application that can support concurrent asynchronous data collection for outcome-based timed observation activities.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a front view of a mobile handheld computer screen of the electronic recording system of the present invention;

FIG. 2 is a schematic perspective view of an observer's relative position to a set of clustered emission sources showing an application of the recording system;

FIG. 3 is a front view of a mobile handheld computer screen of the electronic recording system representing a state of active asynchronous data collection and also showing the alternate state of any dual-state controls; and

FIG. 4 is a flow diagram illustrating data collection, data transmission, and data transformation steps associated with the present invention.

### DETAILED DESCRIPTION OF THE PREFERRED EMBODIMENTS

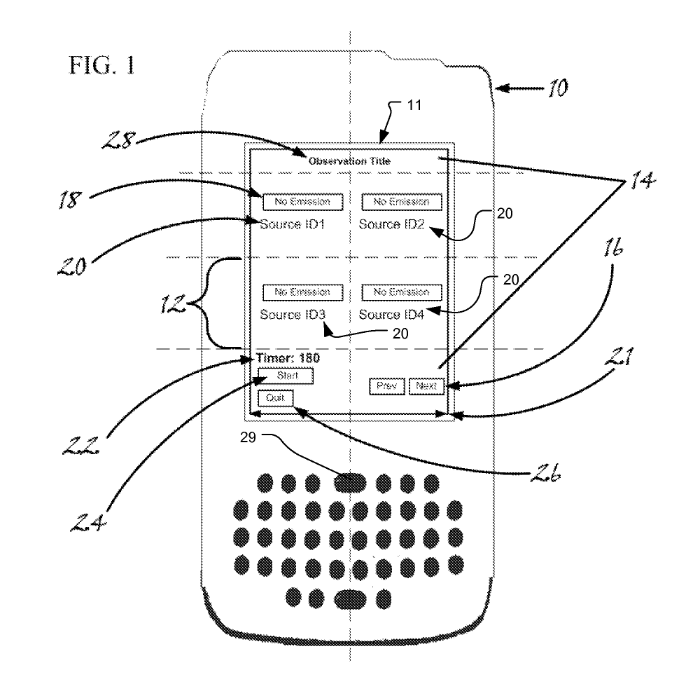

FIG. 1 shows a handheld computer 10 with the software-based mobile electronic recording system that has been constructed according to the principles.

A display 11 of the computer 10 presents a user interface. In one embodiment, the display 11 is a touch screen that is controlled by contact by user. In other examples, the user manipulates a trackball type pointing device 29. Elements of the user interface support the provisioning of timed asynchronous collection of data for up to four observation sources, in the illustrated embodiment.

These four sources are represented in sequential order from top-left to lower-right by a source identifier 20 as SourceID1, SourceID2, SourceID3, and SourceID4 respectively.

The actively viewable user interface screen area accommodates the display of any number of sources that are less than or equal to four without the use of a horizontal screen scrolling mechanism 21 and more sources are accommodated with such a screen scrolling mechanism in place. In the latter case with a horizontal scrolling mechanism 21, user interface elements identical to the ones shown in FIG. 1 are generated, but would exist out of the immediate viewing area until accessed by way of the horizontal scrolling mechanism 21, and would be drawn with the appropriate sequentially assigned screen source identifiers 20 in the user interface.

The top and bottom region of the handheld computer 10 screen is designated for the display of common global sets of information that aid with the observation activities in general. This global handheld computer screen area 14 contains an observation title 28 describing the type of activity being performed. The lower region contains an automated visible countdown value 22 that indicates the remaining time for an observation and collection activity of a specified duration. The lower region of the screen also contains a dual-state start and reset button 24 to either start or reset the automated countdown 22 process. The remaining two functions that are available in the lower common screen region are the navigation area 16 which allows access to alternate application subsystems and the quit button 26, used to exit the software application, respectively.

The primary interaction area of the global handheld computer screen that contains four distinct handheld computer screen quadrants 12 allows for different outcomes to be recorded for each source, but occurring within a single timed test duration for all sources. Each quadrant contains a source identifier 20 corresponding to an observation subject. Each quadrant also has a dual-state positive observation button 18 that when initially invoked by the observer will toggle an alternate state and record either a beginning or ending time stamp for the period of invocation for the related source identifier 20 by touching the button or using the trackball 29, for example. This mechanism allows for any combination of positive and negative observation outcomes to be recorded among the collection of sources being observed at a given time.

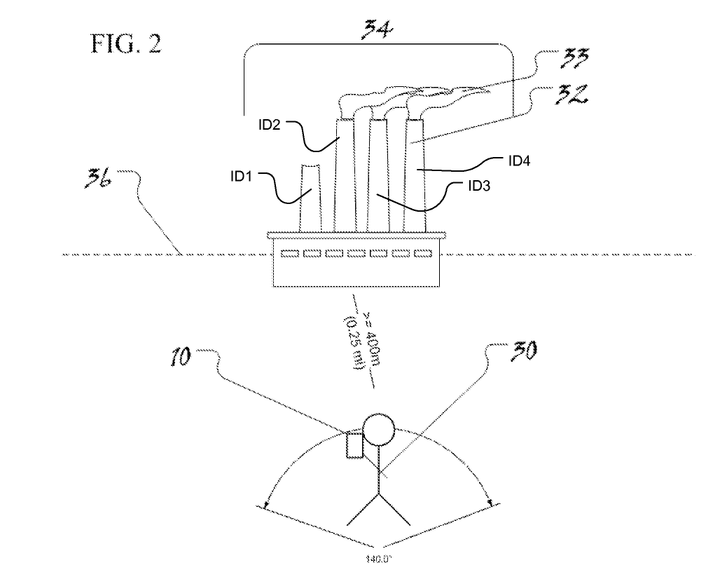

In more detail, with reference to FIG. 1 to FIG. 2, the logical sequence of observation activities is to have the observer 30 with a handheld computer 10 running the mobile electronic recording system software positioned to view a clustered emission source 34. The initial activity is to have the observer select the source identifier 20 for each observation source 32, and to start the automated visible countdown 22 by invoking the dual-state start and reset button 24 at which point the starting duration listed in the automated visible countdown 22 decrements by one second intervals and updates the visible value accordingly.

At this point the observer 30 observes clustered emission sources 34 and records any visible emission activity 33 by invoking the dual-state positive observation button 18 that corresponds to the relevant observation source 32, i.e., ID1, ID2, ID3, and/or ID4.

The observation continues until the automated visible countdown 22 reaches a zero value, indicating that the timed duration of the test has been completed.

The software-based mobile electronic recording system allows for a test to be restarted in the event of an incorrect invocation of a dual-state positive observation button 18 by invoking the dual-state start and reset button 24, at which point the automated visible countdown 22 value is immediately reset to the timed test's full starting value, as indicated by the initial duration.

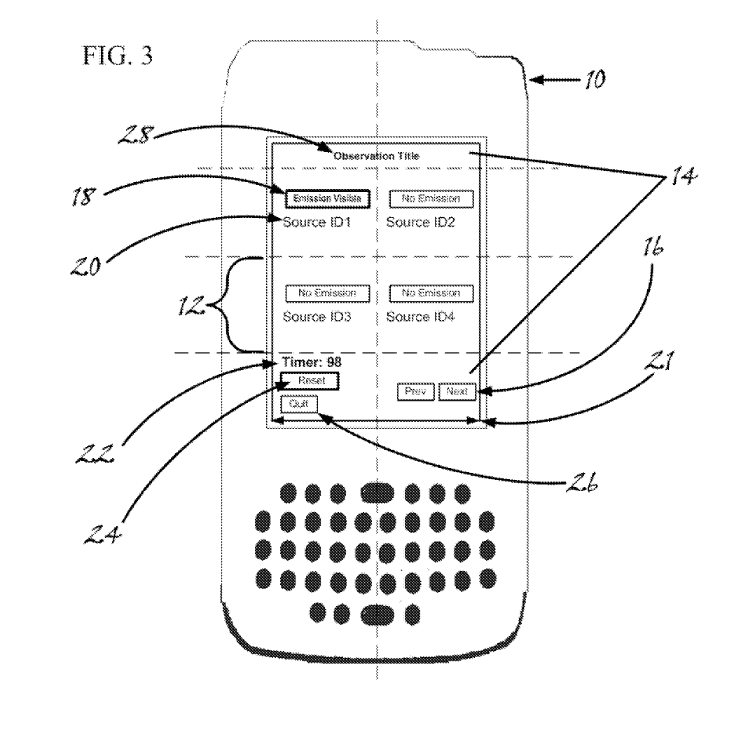

FIG. 3 shows the alternate state for the dual-state start and reset button 24 with running-observation value shown as “Reset.” Once an observation has been initialized, the dual-state start and reset button 24 value is automatically switched to “Reset.” Invocation of the start and reset button 24 while displaying the “Reset” value state will immediately reset the automated visible countdown 22 value to the timed test's full starting value, as indicated by the initial duration.

Upon finalization of an observation activity, the dual-state start and reset button 24 is disabled, as it is no longer of immediate use to the observer 30 who has completed the observation activity.

FIG. 3 also illustrates the alternate value of the dual-state positive observation button 18 from its default state of “No Emission” to its alternate state value of “Emission Visible.” Invocation by the operator 30 while the dual-state positive observation button 18 value reads “No Emission” will record a starting data timestamp and toggle the button state value to its alternate value of “Emission Visible” until the operator invokes the button again which in-turn will record an ending data timestamp and restore the dual-state positive observation button 18 value back to its default value of “No Emission.”

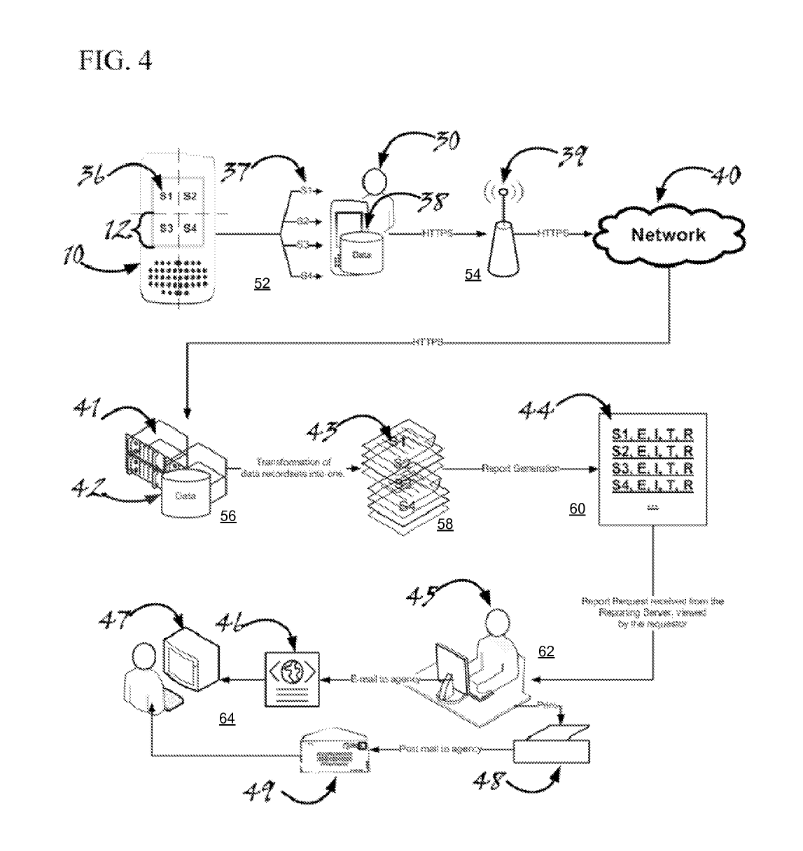

FIG. 4 is a flowchart representing the data collection, data transmission, and data transformation steps associated with the present invention.

In addition to the starting and ending timestamp assignments that are applied when the operator 30 invokes the dual-state positive observation button 18, there are three additional timestamps associated with each observation source record: A scheduled date, a starting date, and a completion date. The scheduled date is the only date among the three mentioned here that is shared with an identical value across each concurrent observation activity on the handheld computer 10.

Step 52 shows the operations necessary to save an individual source observation 36 for each completed record as indicated by the labels “S1, S2, S3, and S4—with S as an abbreviation for SourceID and the numerical values, “1, 2, 3, and 4” representing a simple numbered unique identifier for each source record 37 for the purposes of illustration in this diagram.

A completed observation 36 is stored as an individual local data record 37 in a local database file 38 on the handheld computer 10 for each completed activity that originated in any of the associated distinct handheld computer screen quadrants 12.

In step 54, the handheld computer auto-establishes a connection with a physical or wireless network 39 by way of the handheld computer's 10 operating system. The information is queried from the local database file 38 by the handheld computer 10 and is delivered using the HTTP protocol over a public or private network 40 to an application server 41 which is running a centrally-accessible database server 42. Each source record S1-S4 is stored along with additional data elements that further describe each source record 37 in step 56. The data is transformed a single data record set 43 in step 58 and additional data elements are included and then represented as an observation report 44 in step 60.

For the purposes of illustration: S1, S2, S3, and S4=Source Identifiers for a given observation; E=Equipment Number; I=Inspector; T=Timestamps; R=Result/Outcome are all compiled into the observation report 44.

The observation report 44 containing the related data elements is accessed via web browser by a workstation-equipped user 45 in step 62 who can send the report to a government reporting agency 47, either as a printed report 48 that is post-mailed 49 or as an electronic report mail attachment 46 in step 64.

While this invention has been particularly shown and described with references to preferred embodiments thereof, it will be understood by those skilled in the art that various changes in form and details may be made therein without departing from the scope of the invention encompassed by the appended claims.

What is claimed is:

1. A visual emissions field observation system for observation and recording of concurrent visual emissions from material processing sources, the system comprising
a mobile handheld device have a computer screen and executing a software application that provides recording functions for multiple observation sources concurrently on the computer screen and enabling a user to toggle a timed observation condition separately for each of the multiple material processing sources.

2. A system as claimed in claim 1, wherein four or more concurrent recording functions are displayed on the computer screen in four sections, one for each of the observation sources.

3. A system as claimed in claim 1, wherein each of the recording functions displayed on the computer screen includes a dual-state button that is used to toggle the timed observation condition for a respective one of the material processing sources.

4. A system as claimed in claim 1, wherein each of the recording functions displayed on the computer screen includes an observation source identifier, to associate a material processing source to a specific portion of the computer screen.

5. A system as claimed in claim 1, wherein the screen displays an automated visible countdown value.

6. A system as claimed in claim 1, wherein the screen displays a reset function.

7. A system as claimed in claim 1, further comprising an application server, the mobile handheld device transmitting observation source records to the application server based on the timed observation condition for each of the multiple material processing sources.

8. A system as claimed in claim 7, wherein the application server generates an observation report based on the observation source records, which is transmitted to a government reporting agency.

9. A method for observation and recording of concurrent visual emissions from material processing sources, the method comprising
executing a software application on a mobile handheld device;
the software application providing recording functions for multiple observation sources concurrently on a computer screen of the mobile handheld device; and
enabling a user to toggle a timed observation condition separately for each of the multiple material processing sources by activation of the computer screen.

10. A method as claimed in claim 9, further comprising four or more concurrent recording functions displayed on the computer screen in four sections, one for each observation source.

11. A method as claimed in claim 9, wherein each of the recording functions displayed on the computer screen includes a dual-state button that is used to toggle the time observation for a respective one of the material processing sources.

12. A method as claimed in claim 9, wherein each of the recording functions displayed on the computer screen includes an observation source identifier to associate a material processing source to a specific portion of the computer screen.

13. A method as claimed in claim 9, further comprising displaying an automated visible countdown value.

14. A method as claimed in claim 9, further comprising displaying a reset function.

15. A method as claimed in claim 9, further comprising transmitting observation source records to an application server that are based on the timed observation condition for each of the multiple material processing sources.

16. A method as claimed in claim 15, further comprising the application server generating an observation report based on the observation source records, which is transmitted to a government reporting agency.
